(19) United States
(12) Patent Application Publication
(10) Pub. No.: US 2019/0128028 A1
(43) Pub. Date: May 2, 2019

(54) DUAL MECHANICAL AND ELECTRICAL HOOD RELEASE SYSTEM

(71) Applicant: Ford Global Technologies, LLC, Dearborn, MI (US)

(72) Inventors: Thomas Michael Herline, Canton, MI (US); Kosta Papanikolaou, Huntington Woods, MI (US); Timothy John Zuraw, Canton, MI (US)

(21) Appl. No.: 15/800,665

(22) Filed: Nov. 1, 2017

(51) Int. Cl. E05B 83/24; E05B 81/14

(52) U.S. Cl. CPC E05B 83/24; E05B 77/54; E05B 81/14

(57) ABSTRACT

A latch release system for a vehicle includes a latch assembly securing a front hood covering a front compartment. The latch assembly includes a primary latch and a secondary latch. A lever is coupled to the latch assembly for triggering unlatching of the front hood. A powered actuator is coupled to move the lever. A handle is coupled to move the lever. A switch located within the front compartment commands actuation of the powered actuator. A method is also disclosed.

### TECHNICAL FIELD

This disclosure relates to an assembly and method of securing and opening a front hood both electrically and mechanically.

### BACKGROUND

Vehicles typically include a hood that covers a front engine compartment. The hood latch for the front of the vehicle includes both a primary and secondary latch that secures the hood and prevents errant opening. A front engine compartment is not considered a compartment in which a person can become trapped and therefore does not require an internally accessible latch release system. Vehicle designs are evolving and include rearrangement of fundamental vehicle structures and therefore some vehicle designs may include a front storage compartment covered with a hood. The addition of a front storage compartment of a size sufficient for a person presents additional requirements and challenges for a front hood latch release system.

### SUMMARY

A latch release system for a vehicle according to an exemplary aspect of the present disclosure includes, among other things, a latch assembly securing a front hood covering a front compartment. The latch assembly includes a primary latch and a secondary latch. A lever is coupled to the latch assembly for triggering unlatching of the front hood. A powered actuator is coupled to move the lever. A handle is coupled to move the lever. A switch located within the front compartment commands actuation of the powered actuator.

In a further non-limiting embodiment of the foregoing latch release system, the lever is located remote from the latch assembly and coupled to the latch assembly through a first mechanical link.

In a further non-limiting embodiment of any of the foregoing latch systems, the first mechanical link includes a control cable.

In a further non-limiting embodiment of any of the foregoing latch systems, the lever is movable from a rest position to a trigger position and a first movement of the lever to the trigger position unlatches the primary latch and a second movement of the lever to the trigger position unlatches the secondary latch.

In a further non-limiting embodiment of any of the foregoing latch systems, the lever is movable by the powered actuator and the handle from the rest position to the trigger position.

In a further non-limiting embodiment of any of the foregoing latch systems, the handle is disposed within an interior cabin of the vehicle and coupled to the lever through a second mechanical link.

In a further non-limiting embodiment of any of the foregoing latch systems, a controller governs operation of the powered actuator. The controller enables operation to move the lever to the trigger position to unlatch the primary latch responsive to an indication that the vehicle is operating above a predefined speed threshold.

In a further non-limiting embodiment of any of the foregoing latch systems, in response to actuation of the switch, the controller generates commands controlling operation of the powered actuator to generate the first movement of the lever to the trigger position followed by the second movement of the lever to the trigger position when the vehicle is operating below the predefined speed threshold.

In a further non-limiting embodiment of any of the foregoing latch systems, the lever and the powered actuator are supported on a common base plate and mounted at location remote from the latch assembly.

In a further non-limiting embodiment of any of the foregoing latch systems, the lever is coupled to the powered actuator by a connecting pin.

In a further non-limiting embodiment of any of the foregoing latch systems, the lever is mounted about a pivot pin to the base plate.

In a further non-limiting embodiment of any of the foregoing latch systems, at least a portion of the front compartment includes an open storage space.

A method of operating a latch release system for a front hood of a motor vehicle according to another exemplary aspect of the present disclosure includes, among other things, determining a speed of a motor vehicle. A latch assembly is coupled to a powered actuator and a release handle. Operation of the powered actuator is initiated with a switch located within the front compartment. Unlatching of a front hood is triggered with the powered actuator responsive to the determined speed being less than a predefined speed threshold.

In a further non-limiting embodiment of the foregoing method, a lever is coupled to the latch assembly and triggering unlatching of the latch assembly by moving the lever from a rest position to a triggered position.

In a further non-limiting embodiment of any of the foregoing methods, the latch assembly includes a primary latch and a secondary latch and triggering unlatching of the hood includes triggering a first movement of the lever to the trigger position to unlatch the primary latch and triggering a second movement of the lever to the trigger position to unlatch the secondary latch.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a schematic view of a latch release system for a motor vehicle including a front compartment.

FIG. 2 is a schematic view of the example latch release system.

### DETAILED DESCRIPTION

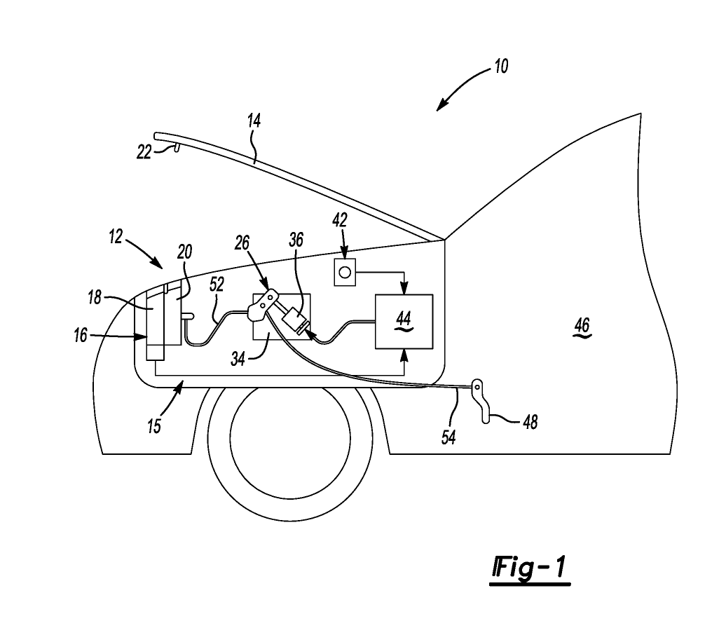

Referring to FIG. 1, a motor vehicle 10 includes a front compartment 12 that is closed by a front hood 14. The front compartment 12 includes sufficient open storage space for storage of miscellaneous items. Because the front compartment 12 includes a space for items and is of a size that could potentially accommodate a person, a latch release system 15 is provided that enables unlatching of the hood 14 from within the front compartment 12. Moreover, the example latch release system 15 includes a latch assembly 16 with a primary latch 18 and a secondary latch 20 for maintaining the front hood 14 in a closed and latched condition when the vehicle 10 is over a predetermined speed threshold.

The latch assembly 16 is coupled through a mechanical link 52 to a lever 26. The lever 26 is actuatable by a powered actuator 36 and by a release handle 48 disposed within a vehicle interior cabin 46. The release handle 48 is coupled through a mechanical link 54 to the lever 26 disposed within the front compartment 12. The powered actuator 36 is controlled by a controller 44 that receives signals from the latch assembly 16 that indicate if the hood 14 is in an open or closed position. The controller 44 is also in communication with a safety switch 42 that is disposed and mounted within the front compartment 12. The safety switch 42 sends signals to the controller 44 that in turn controls the actuator 36 to initiate triggering and unlatching of the latch assembly 16 when the vehicle 10 is below a predefined speed threshold.

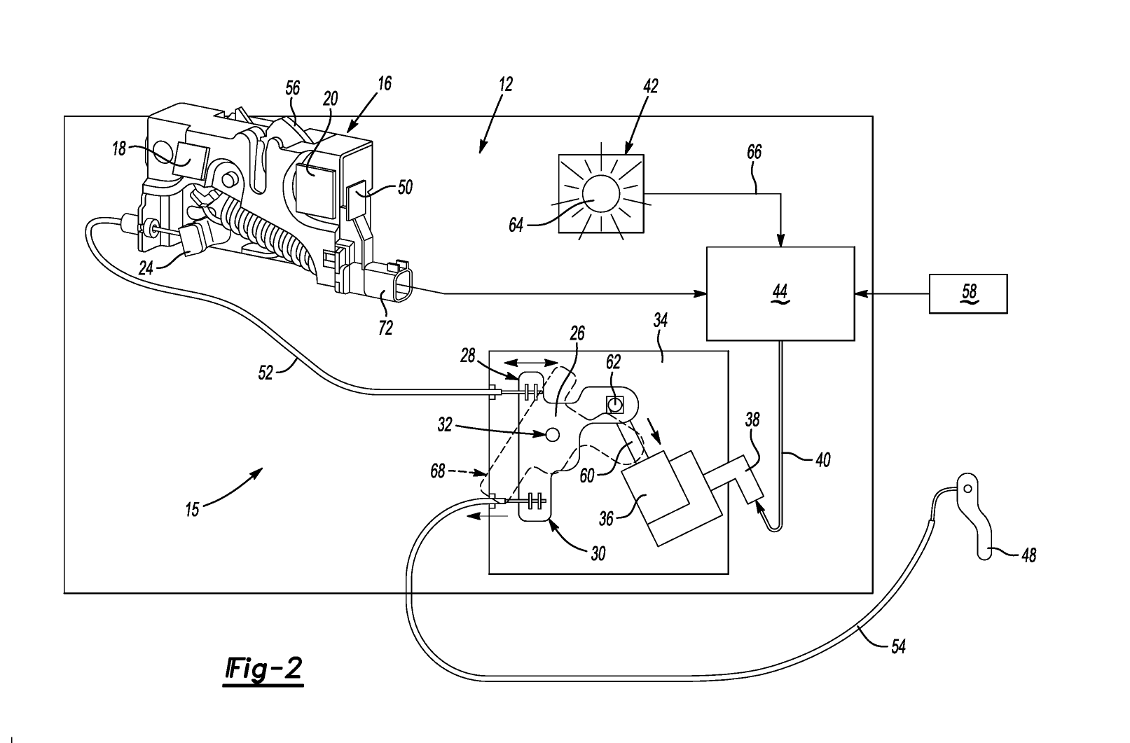

Referring to FIG. 2 with continued reference to FIG. 1, the example latch release system 15 is schematically shown and is disposed within the front compartment 12 of the motor vehicle 10. The latch assembly 16 is shown schematically with a primary latch 18 and a secondary latch 20 that must both be triggered and unlatched in order to free a locking pawl 56 from a catch 22 disposed on the front hood 14. The example latch assembly 16 also includes a hood position sensor 50 that communicates a signal through a connector 72 to the controller 44. The signal is indicative of a position of the hood 14. The latch assembly 16 includes a mechanical lever 24 that is coupled to the remotely located lever 26.

In the disclosed example embodiment, the lever 26 is pivotally supported to a base 34 by a pivot pin 32. The base 34 is supported within the compartment 12, or proximate the compartment 12. Although the base 34 is shown schematically within the compartment 12, the base 34, the powered actuator 36 and lever 26 can be located in any location within the vehicle because actuation forces are transmitted through the control cable 52.

The lever 26 includes a first end 28 and a second end 30 and is pivotally mounted about a pivot pin 32 to the base 34. The first end 28 of the lever 26 is coupled to the mechanical link 52 that is in turn coupled to the lever 24 of the latch assembly 16. In this example, the mechanical link 52 is a control cable that transmits tension through a shrouded outer sheath to pull on the lever 24 of the latch assembly 16. It should be appreciated that although a control cable 52 is shown and described by way of example, other mechanical control linkages including rods or other fixed or flexible linkages capable of transmitting forces are also within the contemplation of this disclosure.

The second end 30 of the lever 26 is mechanically coupled to a manually operated release handle 48 that is disposed within a vehicle cabin 46. The release handle 48 is coupled to the lever 26 through a mechanical link 54. In this example, the mechanical link 54 is a control cable that includes an internal wire or cable that moves within a static sheath to apply a tension force on second end 30 of the lever 26.

The powered actuator 36 includes a shaft 60 that is attached to the lever 26 by a converting pin 62. The lever 26 and the powered actuator 36 are mounted to the common base plate 34. The powered actuator 36 includes an electrical connector 38 that provides a communication link schematically shown at 40 to the controller 44. The powered actuator 36 is schematically shown and may be a solenoid, electric motor or other powered actuator and mechanism capable of moving the lever 26 to a trigger position.

The example latch assembly 16 is a dual pull hood latch assembly that requires two pulls on the lever 24 to first unlatch the primary latch 18, then unlatch the secondary latch 20. Accordingly, unlatching of the latch assembly 16 requires a first movement of the lever 26 from a rest position to the triggered position schematically shown at 68. The first movement of the lever 26 from the rest position to the trigger position 68 pulls the lever 24 to unlatch the primary latch 18. A subsequent or second movement of the lever 26 from the rest position to the triggered position unlatches the secondary latch 20. Accordingly, the lever 26 must be moved from the rest position to the trigger position twice before the latch assembly 16 will fully release from the catch 22 of the front hood 14. Therefore, the powered actuator 36 or the release handle 48 must each be actuated twice to move the lever 26 to the triggered position 68.

The latch assembly 16 may include any known mechanical configuration that executes the dual pull release of the primary and secondary latches 18, 20. Any latch assembly 16 that provides a dual pull function as described is compatible and within the contemplation of this disclosure.

The example front compartment 12 includes sufficient space to fit a person and therefore must include some mechanism to enable unlatching from within the front compartment 12. The safety switch 42 is provided and mounted within the compartment 12 such that button 64 is visible and accessible. The button 64 is illuminated by a phosphorous paint or other passive illuminated coating that is visible by an occupant or person within the closed front compartment 12.

Actuation of the switch 42 is communicated to the controller 44 that in turn generates commands to the powered actuator 36. Controller 44 receives information schematically indicated at 58 indicative of a vehicle speed. If upon actuation of the switch 42, the vehicle 10 is below a desired threshold speed, the controller 44 will initiate triggering of the powered actuator 36 to move the lever 26 to the triggered position twice to unlatch both the primary and secondary latches 18, 20 of the latch assembly 16 and release the catch 22 so that the front hood 14 may be raised.

If the controller 44 receives information about vehicle speed that indicates that the vehicle is above the predefined speed threshold, the controller 44 will command the powered actuator 36 to move the lever 26 to the triggered position a first time to unlatch the primary latch 18. However, the controller 44 will wait until such time as the vehicle 10 is below the desired threshold speed before triggering the powered actuator 36 to further move the lever 26 to the triggered position and thereby release the secondary latch 20. The controller 44 may require additional checks if the first attempt to open initiate opening of the primary latch 36 and the secondary 20 was delayed due to the vehicle being above the predefined speed threshold. The controller 44 may require a repeated actuation of the switch 42 or other repeated prompt.

Accordingly, the example latch release system includes features required to both maintain the front hood 14 in a closed position and enable opening of the latch assembly from within the front compartment 12. Moreover, the lever 26 and the powered actuator 36 are supported on a common base 34 that is spaced apart from the latch assembly 16. The implementation of the flexible mechanical links provides increased possibilities for mounting of the actuator and lever relative to the latch assembly.

Although a specific component relationship is illustrated in the figures of this disclosure, the illustrations are not intended to limit this disclosure. In other words, the placement and orientation of the various components are shown schematically and could vary within the scope of this disclosure. In addition, the various figures accompanying this disclosure are not necessarily to scale, and some features may be exaggerated or minimized to show certain details of a particular component.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A latch release system for a vehicle comprising:
a latch assembly securing a front hood covering a front compartment, the latch assembly including a primary latch and a secondary latch;
a lever coupled to the latch assembly for triggering unlatching of the front hood;
a powered actuator coupled to move the lever;
a handle coupled to move the lever; and
a switch located within the front compartment for commanding actuation of the powered actuator.

2. The system as recited in claim 1, wherein the lever is located remote from the latch assembly and coupled to the latch assembly through a first mechanical link.

3. The system as recited in claim 2, wherein the first mechanical link comprises a control cable.

4. The system as recited in claim 1, wherein the lever is movable from a rest position to a trigger position and a first movement of the lever to the trigger position unlatches the primary latch and a second movement of the lever to the trigger position unlatches the secondary latch.

5. The system as recited in claim 4, wherein the lever is movable by the powered actuator and the handle from the rest position to the trigger position.

6. The system as recited in claim 5, wherein the handle is disposed within an interior cabin of the vehicle and coupled to the lever through a second mechanical link.

7. The system as recited in claim 5, including a controller governing operation of the powered actuator, wherein the controller enables operation to move the lever to the trigger position to unlatch the secondary latch responsive to an indication that the vehicle is operating below a predefined speed threshold.

8. The system as recited in claim 7, wherein in response to actuation of the switch, the controller generates commands controlling operation of the powered actuator to generate a movement of the lever to the trigger position when the vehicle is operating above the predefined speed threshold.

9. The system as recited in claim 7, wherein in response to actuation of the switch, the controller generates commands controlling operation of the powered actuator to generate the first movement of the lever to the trigger position followed by the second movement of the lever to the trigger position when the vehicle is operating below the predefined speed threshold.

10. The system as recited in claim 1, wherein the lever and the powered actuator are supported on a common base plate and mounted at a location remote from the latch assembly.

11. The system as recited in claim 10, wherein the lever is coupled to the powered actuator by a connecting pin.

12. The system as recited in claim 10, wherein the lever is mounted about a pivot pin to the base plate.

13. The system as recited in claim 1, wherein at least a portion of the front compartment comprises an open storage space.

14. A method of operating a latch release system for a front hood of a motor vehicle, the method comprising:
determining a speed of a motor vehicle;
coupling a latch assembly to a powered actuator and a release handle;
initiating operation of the powered actuator with a switch located within the front compartment; and
triggering unlatching of a front hood with the powered actuator responsive to the determined speed being less than a predefined speed threshold.

15. The method as recited in claim 14, including coupling a lever to the latch assembly and triggering unlatching of the latch assembly by moving the lever from a rest position to a triggered position.

16. The method as recited in claim 15, wherein the latch assembly includes a primary latch and a secondary latch and triggering unlatching of the hood comprises triggering a first movement of the lever to the trigger position to unlatch the primary latch and triggering a second movement of the lever to the trigger position to unlatch the secondary latch.
